(19) United States
(12) Patent Application Publication
(10) Pub. No.: US 2014/0289077 A1
(43) Pub. Date: Sep. 25, 2014

(54) Method And System To Facilitate An In-Person Exchange

(71) Applicant: Intercontinental Great Brands LLC, East Hanover, NJ (US)

(72) Inventor: Lawrence A. Osman, Bridgewater, NJ (US)

(73) Assignee: INTERCONTINENTAL GREAT BRANDS LLC, East Hanover, NJ (US)

(21) Appl. No.: 14/349,420

(22) PCT Filed: Oct. 5, 2012
(86) PCT No.: PCT/US2012/058861

§ 371 Date: Apr. 3, 2014

Related U.S. Application Data
(60) Provisional application No. 61/543,933, filed on Oct. 6, 2011.

(51) Int. Cl. G06Q 30/06

(52) U.S. Cl. CPC G06Q 30/0613
USPC 705/26.41

(57) ABSTRACT

Certificates can be redeemed for a physical product during an in-person exchange. This can be based upon providing to a third party, via an electronic data network, an opportunity to select a physical product to provide to a particular recipient via an in-person exchange; receiving from the third party, via an electronic data network, a selection of the physical product to provide to the particular recipient in an in-person exchange; and providing a message to the particular recipient. The message can comprise, at least in part, a certificate that can be redeemed by the particular recipient for the physical product at a retailer and can further comprise transaction-specific validation information that, when utilized by the retailer, will validate a bearer as being authorized to receive the physical product via the in-person exchange without further additional payment from the bearer to the retailer.

The present application relates generally to facilitating selections of physical goods via as electronic data network.

### BACKGROUND

Gift givers currently are somewhat restricted in how they provide physical gifts to gift recipients. For example, oftentimes a gift giver has to obtain the gift and physically deliver the gift or otherwise arrange for a shipping service to provide the physical gift to the gift recipient. However, this can add time-in-transit, significant shipping expense, or be otherwise problematic for the gift giver to assure such delivery.

More recently, gift certificates (including so-called gift cards) have also become popular whereby a gift giver may select a gift certificate having a certain monetary value (such as, for example, twenty-five dollars) permitting the recipient to redeem the gift certificate for whatever products or services the recipient desires (albeit sometimes limited to a particular source or retailer). Of course, though convenient, the gift giver must be careful to ensure that the amount of the gift certificate is adequate to cover the purchase of the intended item (and/or that the gift certificate is not in some amount that greatly exceeds that necessary purchase price).

The applicants have determined, however, that the gift giver may wish to provide the recipient with a specific gift in which case an unrestricted gift certificate may be unhelpful. In such a case the gift giver will often forego the convenience of the gift certificate approach in favor of the aforementioned delivery of the particular intended item(s). As already noted, however, arranging for the item to be delivered, one way or the other, to the intended recipient presents its own suite of difficulties, issues, and concerns.

It should be noted that U.S. Publication No. 2011/0047039 to Crames et al. is directed to a method and system whereby a user can give a gift using a mobile phone or other communication device. However, the system and method described therein requires complex validation of a code or electronic signal identifying the gift transaction. Moreover, the system and method described therein is generally restricted such that a brand manager cannot provide opportunities directly to a third party to gift the brand manager's products to a recipient.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a process flow diagram representing one method for giving a gift and redeeming the gift;

FIG. 2 is a block diagram representing one system for giving a gift;

FIG. 3 is a block diagram representing one method whereby a third party is provided an opportunity to select a gift and a control circuit provides a message regarding the gift to a recipient;

FIG. 4 is a block diagram representing one method whereby a control circuit provides an opportunity to select a gift at a third party display and also provides a message regarding the gift to a recipient;

FIG. 5 is a block diagram representing one method whereby a control circuit validates information to permit a recipient to obtain a physical item gifted to the recipient;

FIG. 6 is a block diagram representing information displayed on a third party display whereby the third party is permitted to select a gift to provide to a recipient; and

FIG. 7 is a block diagram representing various parties that may be involved in gifting a physical object to a recipient.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, a variety of methods and associated systems are described herein for providing an opportunity and authorization for an individual to receive a physical product during an in-person exchange. For example, in one form, the methods and systems described herein may be used for gifting a physical product from a gift giver to a recipient, such as through a website or social networking site, whereby the recipient is provided with a message that may be redeemed during an in-person exchange at a retailer for the physical product without further additional payment from the recipient. The gift giver may select a specific item or a category of items that will be gifted to the recipient and pays for the item or category of item such that the recipient need not provide any additional payment. Moreover, a brand manager may provide the opportunity for the third party to select one or more of the brand manager's products to gift to the recipient. The gift giver may also be given an opportunity to gift a physical item when the gift giver purchases an item first. For example, the gift giver may purchase a sample of an item at a reduced rate and also be given an opportunity to gift the same sample to another person. These and other features will be understood from the following description and figures presented herein.

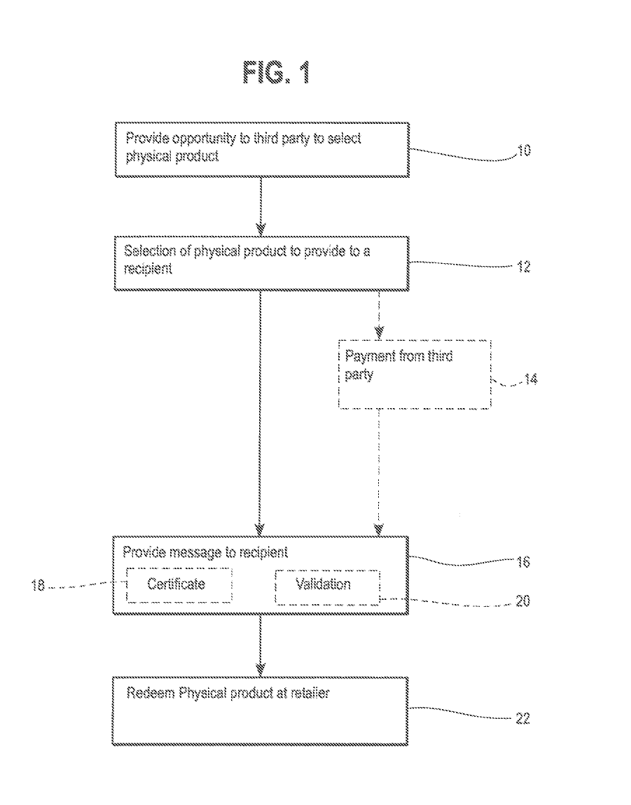

One form of the method is illustrated in the process flow diagram found in FIG. 1. In this form, a third party is provided with an opportunity to select a physical product to provide to a particular recipient during an in-person exchange, as represented by reference number 10. (As used herein, this reference to “party” will be understood to refer to essentially any legally-recognized entity. Accordingly, “party” certainly includes individual persons but can also include, for example, an incorporated entity, a fraternal organization, a partnership, and so forth.) This opportunity may be provided via an electronic data network, such as via the Internet. In yet another form, in lieu of the foregoing or in combination therewith, this opportunity may be provided via a social network, mobile telephony network, a short-message service/multi-media service (SMS/MMS) messaging and the like.

The third party then selects one or more physical products to provide to the recipient during the in-person exchange, as represented by reference number 12. The third party may be provided with a single item or a variety of items to choose from. Similarly, the third party may be allowed to gift a single item or a plurality of (like or dissimilar) items to a single recipient. Additionally, the third party may be permitted in gut me same gift to a plurality of recipients or different gifts to a plurality of recipients. The third party's selection may also be provided via an electronic data network, such as via the Internet. Additionally, this selection may be provided via a social network, mobile phone network, SMS/MMS messaging and the like.

Prior to, concurrent wife, or after the selection 12, the third party will also provide some form of payment, as represent by reference number 14. This payment may also be effected via an electronic data network, such as via the Internet. It should be understood that payment may be made in any number of different manners, such as cash, credit or debit card, bank transfer, wire, and the like. Payments may also be made through other payment processing services such as banks and credit card processing services. In one form, the payment may be through a payment service, such as Paypal™.

In one form, the payment may be in the form of credits, such as social networking credits that were previously obtained. Furthermore, the payments and/or credits may take the form of rewards points. For example, a user may accumulate rewards points for shopping, participating on a social network, donating money or goods to charities and the like. A user may donate money or goods such that the user is rewarded with an opportunity to gift a physical item to him or herself or to another individual. Additionally, a user may accumulate points by participating in a game, such as an online and/or social networking game.

The recipient is provided with a message, as represented by reference number 16. The message may include a number of features. For example, the message may include a certificate 18 that can be redeemed by the recipient for the physical product at the retailer as well as transaction-specific validation information 20.

The validation information 20 may be self-validating, such as a seal, watermark, marking, hologram, an embedded radio-frequency identification (RFID) chip, or the like that is not easily duplicated by an unauthorized party. The validation information 20 may also require internal validation or external validation as described herein. The message may also include a personalized note to the recipient, such as “Happy Birthday,” “Thank You,” or any other personalized message the third party would like to provide to the recipient. This personalized content can be limited to a plurality of candidate messages, if desired, or the third party can be permitted to create a custom textual and/or pictorial message.

If desired, further validation information pertaining in particular to the recipient can be included. This might include, for example, a photo or other image of the recipient's face, their fingerprint(s), or other biometric information of choice and availability.

The entire contents of the “message” can be presented in a single offering or can, if desired, be parsed into a plurality of independent offerings that together constitute the “message.” The message may be delivered in any number of different manners. For example, the message may be delivered via a facsimile, cable, or telegram transmission or in an electronic format, such as a text message, email, mobile device applications, social network message or the like. These teachings will also accommodate physical delivery, such as through standard mail (or a private courier or delivery service such as United Parcel Service or FedEx). These teachings will also accommodate, if desired, conveying a first part of the message via a pushed message (such as an email) and requiring the recipient to pull a remaining portion of the message to themselves via, for example, an Internet link mat appears in a pushed email.

The certificate 18 may take a variety of forms and include a variety of different information. For example, the certificate 18 may be a physical piece of paper (or other paperstock offering) such as would be mailed to the recipient or otherwise printed out by the recipient. The certificate 18 may also be in electronic form, such as an electronic signal or code, an email, a link to a website, a text message, or other form of electronic communication. The certificate 18 may also include information such as the recipient's name, identification of the physical product, a specified retail location, a link to visit a website for the recipient to specify a retail location, expiration date and the like.

The transaction-specific validation information 20 may similarly take a variety of forms and include a variety of information. As noted above, the transaction-specific validation may be self-validating, require internal validation by a retailer and/or require external validation outside of the retailer. For example, the transaction-specific validation information 20 may be self-validating and include holograms, watermarked paper, unique paper or backing material, or other physical properties that are not easily duplicated.

If the transaction-specific validation information 20 is internally validated by a retailer. It may include, if desired, a constantly-changing code number that may be synced with a clock or other reference source at a retailer such that the code is known by the retailer. Similarly, the transaction-specific validation information 20 may include other information that may be quickly validated internally by the retailer.

If the transaction-specific validation information 20 is externally validated outside the retailer, the transaction-specific validation information 20 may include any information that may be readily transferred between the retailer and an external validation source. For example, the external validation source may be the brand manager or other entity, such as a transaction clearinghouse.

Additionally, the transaction-specific information 20 may exist in a physical form, such as a printed code, series of symbols and the like which may take the form of a certificate or physical voucher. The transaction-specific information 20 may also be in electronic form. For example, the transaction-specific information 20 may be a code existing on a screen, a code stored in an electronic memory and the like. These electronic forms may be transmitted in a number of different manners including, but not limited to, an infrared signal, a Bluetooth signal, an 802.11-compatible signal (often referred to as Wi-Fi), a wide-area wireless system such as a cellular telephony system, and other electronic forms.

The recipient can communicate or otherwise provide the message, certificate and/or physical voucher to the retailer in a number of manners and thereby redeem the foregoing for the physical product, as represented by reference number 22. For example, the transaction-specific validation information can be provided such as by manually entering the code into the retailer's point-of-sale system at a physical store location, by wireless transmission between the recipient (mobile phone, tablet, laptop and the like) and the retailer's point-of-sale system and the like.

It should be noted that, in one form, the recipient may be permitted to decide when and where to receive or redeem the gifted physical product. In this regard, when the recipient is provided with the message, as at 16, the recipient may be provided with an opportunity to choose from a list of retailers and/or retail locations. For example, the retailers may include a list of retail chain(s), retail locations, vending machine locations and the like. The recipient may also be provided with an opportunity to enter his or her physical location or address such that the recipient may be provided with a listing of nearby retailers and/or retail locations.

For example, the recipient may enter a location, and will be provided with retailers and/or retail locations that are adjacent the location, such as within 1 mile, 3 miles, 5 miles and the like. The recipient may enter a specified distance to indicate what is adjacent or the system may automatically provide a listing within a predetermined distance (such as within a universal default distance or within a distance that the recipient has previously selected when establishing a profile in these regards). Alternatively, the system may automatically determine which retailer and/or retail location the recipient may use for redemption using determination criteria that may or may not be based, in whole or in part, upon the recipient's location or address.

The third party also may be permitted to enter a specific location and/or time to redeem the physical product so the third party and recipient may meet in some prearranged manner, if desired.

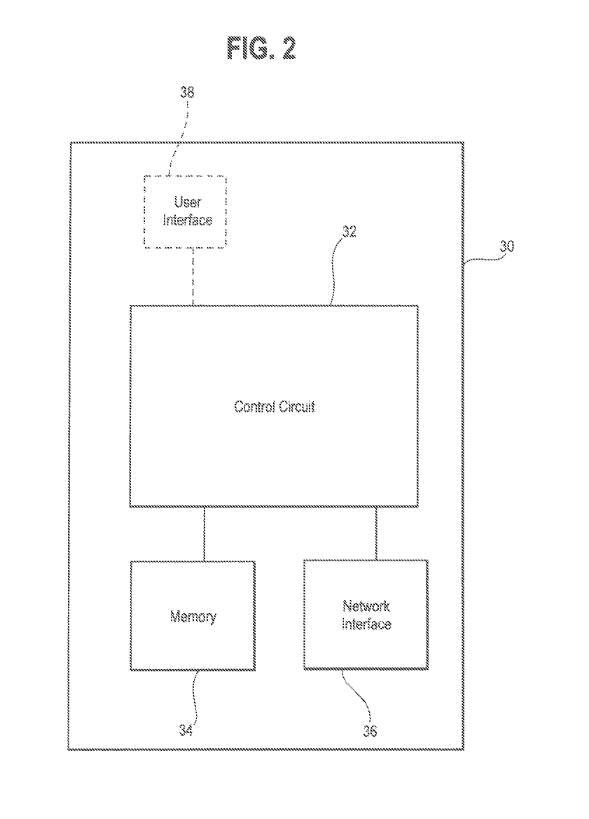

One form of a system will now be described with reference to FIG. 2. FIG. 2 illustrates a system 30 including a control circuit 32, a memory 34 and a network Interface 36. The system also optionally includes or otherwise is operably connected to a user interface 38 whereby a user may access the system. It should be noted that the user interface 38 may be located remotely from the system, such as at a third party's computer, mobile phone, laptop and the like.

The system 30 may take a variety of forms including, but not limited to, one or more servers, computers, portions of servers or computers, and the like as understood by those skilled in the art. The system 30 may also take the form of a mobile phone, tablet, portable or other electronic device. For example, the system may be a server whereby a user may access the system 30 via his or her mobile device. Alternatively, the system 30 may take the form of the user's mobile device that accesses a server or database remotely or a retailer's computer system.

The control circuit 32 may also take a variety of forms including, but not limited to, one or more processors, hardware, software and the like. The present teachings will readily accommodate using a control circuit that comprises a dedicated-purpose hard-wired platform or a partially or wholly-programmable platform as desired. The memory 34 may also take a variety of forms including, but not limited to, one or more electronic memory units including but not limited to read-only memory (ROM), random-access memory (RAM), hard drive(s), and the like. The memory 34 may be operably coupled to the control circuit 32 to provide data, access to one or more databases, and other information to the control circuit 32. The network interface 36 may also take a variety of forms including, but not limited to, a modem, Ethernet, Wi-Fi, cellular, satellite and other electronic communications forms. For example, the network interface may be configured to interface with a wide-area network (WAN), a local-area network (LAN), the Internet, SMS/MMS messaging, cellular connections, social networks and the like.

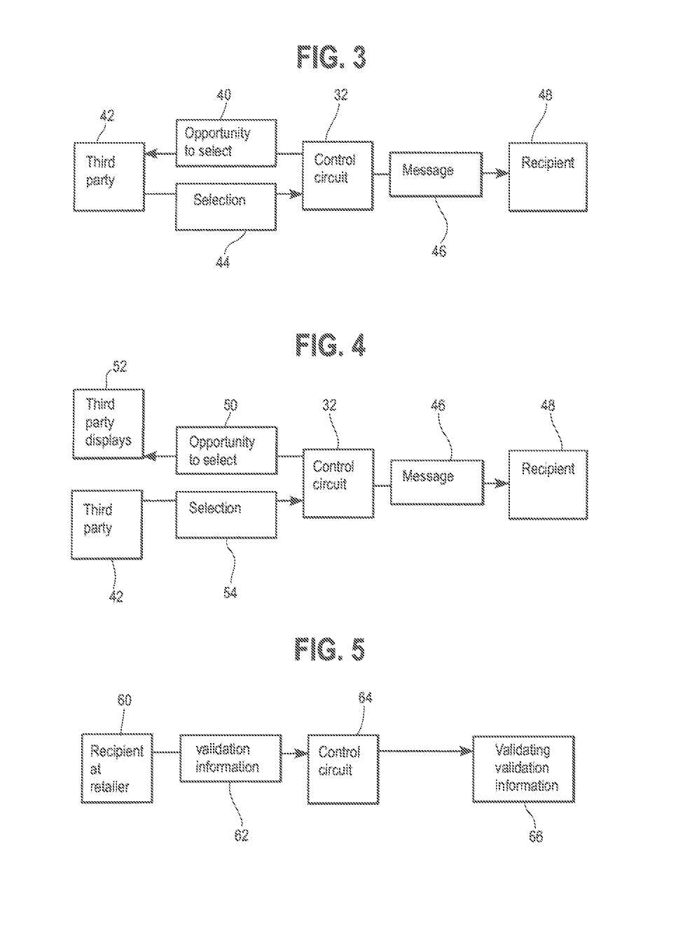

Various processes using such a system 30 will now be described with reference to FIGS. 3-5. Referring to FIG. 3, one form of a process using the control circuit 32 is illustrated. The control circuit 32 provides an opportunity to select one or more physical items to gift to a recipient as shown at reference 40. The opportunity 40 is provided to a third party 42, which may be done via an electronic data network such as, but not limited to, the Internet, a social network (such as, but not limited to, Face-book, MySpace, LinkedIn, Google Plus and so forth), SMS/MMS messaging, email and the like. The third party 42 may then utilize that opportunity to make the proffered selection, as at reference number 44, the selection being sent to the control circuit 32. It should be understood that the third party 42 need not make the selection 44 using the same method of transmission as served to present the opportunity to the third party 42. For example, the third party 42 may be given the opportunity to select via an email message or advertisement on a website or social network page. In such a case the third party 42 may make the selection 44 using the same form of conveyance or a different form, such as by sending a text message with a code or making a selection via a telephone-based system. The control circuit 32 will then provide a message 46 to the recipient 48 containing information as described above. The message can be provided in an electronic form or as a physical voucher.

Another form of a process using the control circuit 32 is shown in FIG. 4. In this form, an opportunity to select one or more physical items to gift to a recipient, as at reference 50, is provided to a third party display 52. In this regard, the third party display 52 may be at a retail location, such as a particular retail establishment or stand-alone kiosk, or at a non-retail remote location such as a computer screen (at, for example, a person's residence), a mobile phone screen and the like. The third party 42 may then make a selection at 54 using the third party display 52 as a display and/or a selection device, as in the case of a touch screen. The control circuit 32 will then continue as described above for FIG. 3.

Yet another form of a process is shown in FIG. 5. In this form, a recipient at a retailer, as shown at reference number 60 provides validation information, as shown at reference number 62. As previously discussed, the validation information 62 may take a variety of forms including, but not limited to, electronic, displayable, physical, printable and the like. The validation information is provided to an on-site or remotely located control circuit 64, which may be a cash register, payment processing system and the like. The control circuit 64 then validates the validation information as shown at reference number 66. This validation may include validating a code or other information regarding the redemption for the physical item. Once the validation information has been validated, the recipient may be permitted to complete the transaction then and there and obtain the gifted physical item at that location without further payment, obligation, or the like.

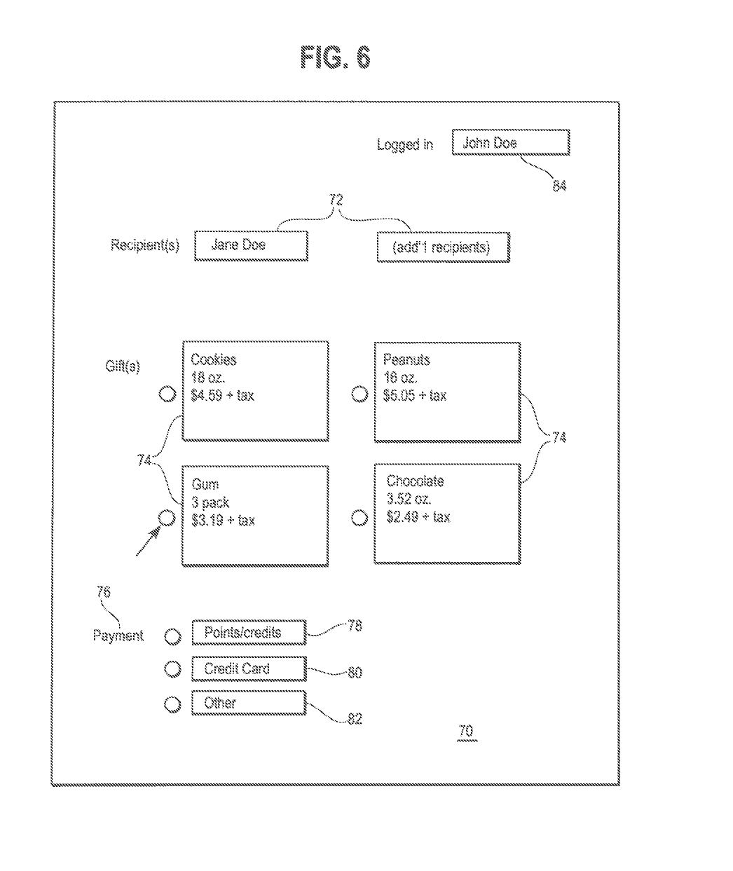

FIG. 6 represents one form of a website or other electronically accessible system for viewing and selecting physical items to gift to a recipient. For example, a webpage 70 is shown that may be accessible by the third party and/or the gift recipient. For example, the third party may access the webpage 70 to gift physical items while the recipient may go to the webpage to obtain the message, view the physical item, make selections regarding the redemption for the physical item (such as selecting a particular location to receive the physical item or scheduling a particular time to receive the physical item) and the like. The webpage 70 may be modified depending on which party is accessing the webpage 70.

The webpage 70 may include features such as recipient designations 72 whereby the third party may enter information regarding the recipient(s). The third party may enter information including, but not limited to, the recipient's name, email address, street address, phone number, login name, social networking credentials and cither identifying or characterizing information.

The webpage 70 may also include one or more product identifications 74. The product identification 74 may include a plurality of products that may be sorted by price, style, location, availability and the like. The products may also be grouped into packages that may also be gifted. The third party may select one or more of the products listed to gift to the one or more recipients. Similarly, the products may be searched by price, location, availability and type to note but a few examples in these regards.

The gift can be any physical product or tangible item. Examples of gifts that can be selected include, but are not limited to: books, food or beverage items, consumer products, books, and other physical goods ranging, for example, from simple commodity Items to so-called luxury items.

Further, the webpage 70 may include payment information 76 permitting the third party to select how the gift will be paid for. For example, the payment information may include points or credits 78, credit card 80 or other forms 82 of compensation. It should be understood that the webpage 70 may be provided such that other forms of payment may also be accepted. It should be noted that the third party may provide for payment terms, but does not actually pay for the gifted item until the item is redeemed. In this regard, the overall price of the gifted item may not be precisely known at the time the gift is chosen by the third party as the redemption location and applicable taxes may not be known.

In one form, the webpage 70 is part of a social network such that the third party may log in to the system, such as shown at reference 84. By logging in, the third party's information, such as payment information, address book, contact lists and the like may be readily available for selection. In this regard, the third party will be able to quickly select the gift recipient, payment information and the like without having to manually enter all of the information at each transaction. For example, the third party may enter or begin entering the social networking name of the gift recipient and the webpage 70 may automatically begin filling in the rest of the name and/or the contact details for the gift recipient.

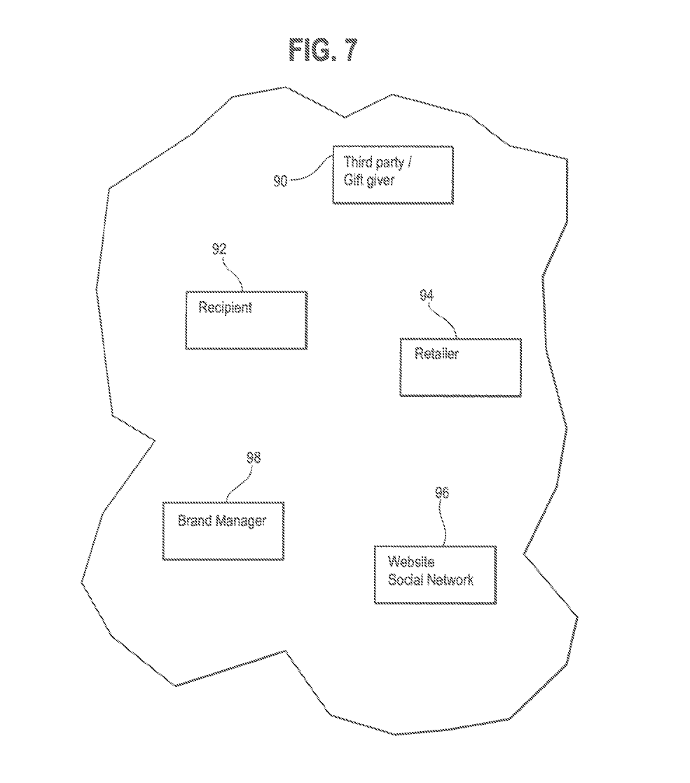

Any number of different parties may be involved and/or participate in the methods described herein. For example, referring to FIG. 7, a number of different parties are identified. More specifically, a third party or gift giver 90 may be involved to initiate a transaction which may involve one or more recipients 92 obtaining a physical product from a retailer 94. The transaction may also involve a website or social network 96 for facilitating the selection of the physical product and identification of the recipient 92. Additionally, a brand manager 98 may provide or otherwise be involved with the one or more of the physical products involved in the transaction.

It should be understood that one or more of the above noted parties may overlap. For example, the gift giver 90 and recipient 92 may be the same entity while the retailer 14 and manufacturer 18 may be the same entity. The retailer 94 may be any business that provides the physical product for sale and/or for redemption. The retailer 94 may have a brick and mortar location and may also hike the form of a vending machine or kiosk.

The brand manager may be a manufacturer, a private labeler, a brand owner, a brand agent and/or a representative of a brand of the physical item that may be gifted to a recipient. In one form, a brand manager, such as a manufacturer, may cooperate with a social network to provide its products as potential gifts. In this regard, such a method may provide an opportunity for the brand manager to directly interact with potential customers without necessarily having its own retail establishment. In another form, the brand manager may provide an opportunity for followers of the brand manager on a social network to be given an opportunity to gift one of the brand manager's products to another individual, thereby potentially increasing the customer base.

Additionally, other parties may also be involved in the transaction. For example, advertisers, website operators, payment processors, fulfillment processors and the like may be involved In one or more aspects of the transaction.

These teachings are highly flexible in practice and will accommodate a wide range of approaches in these regards. These approaches are also highly scalable and will accommodate, for example, a vast range of implementing network architectures and communications opportunities, giftable items, and redemption venues. It will further be appreciated that these teachings can be implemented in a highly-economical ways as well and can serve, for example, to greatly leverage many existing platforms and systems to expand the use and value of those legacy approaches.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants contribution. As but one example in these regards, these teachings will readily accommodate using known information regarding a potential gift recipient (such as their birth date or that the potential gift recipient has just, for example, graduated from college or landed a new job) to proactively present the aforementioned opportunity to a known friend of the potential gift recipient at appropriate and suitable gift-giving times and occasions. The actual scope of the protection sought is intended to be defined in the following claims when viewed in their proper perspective based on the prior art.

1. A method comprising:
by a control circuit:
providing to a third party, via an electronic data network, an opportunity from a brand manager to select a physical product from the brand manager to provide to a particular recipient via an in-person exchange;
receiving from the third party, via an electronic data network, a selection of the physical product to provide to the particular recipient in an in-person exchange; and
providing a message to the particular recipient, the message comprising, at least in part:
a certificate that can be redeemed by the particular recipient for the physical product at a retailer; and
transaction-specific validation information that, when utilized by the retailer, will validate a bearer of the certificate as being authorized to receive the physical product via the in-person exchange without further additional payment from the bearer to the retailer.

2. The method of claim 1 wherein the message further comprises identification of the retailer.

3. The method of claim 2 wherein the retailer is identified as a member of a chain of retail affiliates.

4. The method of claim 2 wherein the retailer is identified as being located at a specific location.

5. The method of claim 2 wherein the retailer is a vending machine.

6. The method of claim 1 wherein the transaction-specific validation information is provided in a visual form, the visual form being configured for at least one of printing and displaying at the retailer on an electronic device.

7. The method of claim 1 wherein the transaction-specific validation information is provided in an electronic form configured to be transferred to the retailer via a wireless signal.

8. The method of claim 1 wherein the certificate is in a physical form including at least one fraud-prevention feature.

9. The method of claim 1 wherein providing a message to the particular recipient comprises providing the message via an electronic data network.

10. The method of claim 1 wherein the brand manager is an entity selected from the group consisting of a manufacturer of the physical product, a private labeler of the physical product, a brand owner of a brand of the physical object, a brand agent for a brand of the physical object and a representative of the brand for the physical object.

11. A method comprising:
by a control circuit:
providing to a third party, via an electronic data network, an opportunity from a brand manager to select a physical product from the brand manager to provide to a particular recipient via an in-person exchange;
receiving from the third party, via an electronic data network, a selection of the physical product to provide to the particular recipient in an in-person exchange;
providing a physical voucher to the particular recipient, the physical voucher comprising, at least in part:
transaction-specific validation information that, when utilized by the retailer, will validate a bearer of the physical voucher as being authorized to receive the physical product via the in-person exchange without further additional payment from the bearer to the retailer, and self-validating indicia verifying that the physical voucher is authentic.

12. The method of claim 11 wherein the physical voucher further comprises identification of the retailer.

13. The method of claim 11 wherein she retailer is identified as a member of a chain of retail affiliates.

14. The method of claim 11 wherein the retailer is identified as being located at a specific retail location.

15. The method of claim 11 wherein the at least one retailer is a vending machine.

16. A method comprising:
by a control circuit:
providing to a third party, via an electronic data network, an opportunity from a brand manager to select a physical product from the brand manager to provide to a particular recipient via an in-person exchange;
receiving from the third party, via an electronic data network, a selection of the physical product to provide to the particular recipient in an in-person exchange;
verifying an address of the particular recipient;
providing message to the particular recipient, the message comprising, at least in part:
transaction-specific validation information that, when utilized by the retailer, will validate the particular recipient as being authorized to receive the physical product via the in-person exchange without further additional payment from the particular recipient to the retailer, and
identification of a location of the retailer in an area adjacent the address of the particular recipient.

17. The method of claim 16 wherein the retailer is identified as a member of a chain of retail affiliates.

18. The method of claim 16 wherein the retailer is identified as being located at a specific retail location.

19. The method of claim 16 wherein the at least one retailer is a vending machine.

20. The method of claim 16 wherein the transaction-specific validation information is provided in a visual form, the visual form being configured for at least one of printing and displaying at the retailer on an electronic device.

21. The method of claim 16 wherein the transaction-specific validation information is provided in an electronic form configured to be transferred to the retailer via a wireless electronic signal.
